(19) United States
(12) Patent Application Publication
(10) Pub. No.: US 2004/0164055 A1
(43) Pub. Date: Aug. 26, 2004

(54) Nitrogen saving device

(76) Inventors: Ronald L. Black, Clarksville, TN (US); Joe Black, Clarksville, TN (US)

Correspondence Address: Richard C. Litman, LITMAN LAW OFFICES, LTD., P.O. Box 15035, Arlington, VA, 22215, US

(21) Appl. No.: 10/748,226

(22) Filed: Dec. 31, 2003

Related U.S. Application Data
(60) Provisional application No. 60/446,548, filed on Feb. 12, 2003.

(51) Int. Cl. B23K 9/16

(52) U.S. Cl. 219/74

(57) ABSTRACT

In a brazing apparatus, a shutoff valve for an inert purge gas used to protect a copper-based workpiece during brazing, includes a pivoting arm that supports a brazing torch when not in use. When the torch rests on the arm, the purge valve is closed. Conversely, when the torch is removed from the arm for use during brazing, the valve opens to permit purge gas to flow through the workpiece.

### CROSS-REFERENCE TO RELATED APPLICATION

This application claims the benefit of U.S. Provisional Patent Application Serial No. 60/446,548, filed Feb. 12, 2003.

### BACKGROUND OF THE INVENTION

1. Field of the Invention

The present invention relates to purge gas shutoff valves for use in brazing copper-based materials, such as copper tubing used in refrigeration systems. In particular, the nitrogen saver for brazing of the present invention includes a spring-loaded valve for opening and shutting off nitrogen purge gas flowing through a copper-based tubular workpiece that permits flow only when a brazing torch is being used.

2. Description of Related Art

The present invention is directed to a nitrogen saver for brazing in the form of a shutoff valve used to permit flow or to shut off flow of a purging gas (e.g., nitrogen) flowing through a copper-based workpiece being brazed using a brazing torch.

Brazing of copper tubing using an oxyacetylene torch is well known for manufacturing and assembling coolant systems, such as for making or repairing air conditioners and refrigerators. In particular, fittings are brazed to bare copper tubes and copper tubes are brazed to headers to form evaporators and condensers, or to connect coils generally to copper tubes.

The brazing is performed by bringing the ends of the two copper objects together to form a joint, then heating the ends to a brazing temperature of about 1000° F. using a brazing torch. Within seconds of applying the torch to the joint, the joint reaches the desired brazing temperature, and a brazing compound in the form of a paste, for example a silver-based paste, is applied to the joint. The brazing material melts and flows into the joint by capillary action and adheres the two materials together. Upon cooling, a strong joint is formed that holds the ends of the materials together.

In order to avoid wasting fuel (e.g., acetylene) and oxygen during periods when brazing is not being performed, a dual spring-loaded shut-off valve (called a “Gasaver” made by Weldit or Smith Equipment of Watertown, S. Dak.) is used. The shut-off valve includes a movable arm extending from it including a hook at a far end. When the torch is placed on the hook (i.e., when brazing is not being performed), the arm is moved downward and a dual valve simultaneously shuts off both the fuel and oxygen supply. Conversely, when the torch is removed from the arm (i.e., when the torch is being used to braze), the arm is spring-biased to swing upward, opening the dual valve to permit fuel and oxygen to flow to the torch. The tip of the torch is then passed over a pilot flame to ignite the gases flowing out from the tip of the torch and is thus ready for use in brazing.

When brazing copper-based pipes and tubing, the inside of the tubing must be purged during brazing with an insert gas to avoid forming a copper oxide scale. Based on costs, the inert gas is most often nitrogen. The scale forms by reaction of the copper with oxygen at the brazing temperatures. When present, the scale can adversely interfere with operation of the coolant system by circulating through the compressor.

However, when not being used as a purge gas during actual brazing of the article, nitrogen gas is normally wasted by allowing it to continue to flow. Thus, there exists a need to prevent wasting the nitrogen when it is not needed for purging. This invention satisfies this need by providing a nitrogen shut-off valve that is actuated by the same pivoting arm that is connected to the dual valve. More particularly, when the torch rests on the hook of the arm, the nitrogen purging gas supply is shut off along with the fuel and oxygen supply.

U.S. Pat. No. 2,834,368, issued to Gray on May 13, 1958, teaches a hydraulic system including multiple dual valves. U.S. Pat. No. 3,154,089, issued to Anthes on Oct. 27, 1964, teaches a shut-off valve for controlling oxygen-fuel torches, including simultaneous shut-off. U.S. Pat. No. 3,487,853, issued to Kern, Jr. on Jan. 6, 1970, teaches a fluid selector valve in which a single pivoting arm simultaneously shuts off fluid-flow in a plurality of streams.

U.S. Pat. No. 3,698,428, issued to Gastin on Oct. 17, 1972, teaches a valve in which a single actuator operates two valves. U.S. Pat. No. 4,398,560, issued to Black on Aug. 16, 1983, teaches a valve for simultaneously shutting of two gas streams. U.S. Pat. No. 4,454,405, issued to Riley on Jun. 12, 1984, teaches a welding apparatus including an inert gas supply used to purge the inside of a pipe being welded. The reference lacks any teaching regarding the simultaneous shut-off of the welding gases and the purge gas.

U.S. Pat. No. 4,723,064, issued to Bothe, II on Feb. 2, 1988, teaches a purge gas system for welding pipes. Again, no simultaneous purge gas and welding gas shut-off is taught by the reference. U.S. Pat. No. 5,129,420, issued to Johnson on Jul. 14, 1992, teaches a cut-off valve with multiple passageways that are simultaneously shut off. U.S. Pat. No. 5,864,111, issued to Barefoot on Jan. 26, 1999, teaches a welding system including a purging device that is controlled to maintain a constant purge back pressure inside the work.

Thus, the prior art lacks any teaching of a purge gas shut-off valve actuated by placing or removing a brazing torch from a pivoting torch support arm, i.e., when the torch is not being used, it is hung onto the pivoting arm to shut off the flow of the purge gas through the workpiece well as shutting off the flow of the torch gases; and when the torch is removed from the pivoting arm for use to braze a workpiece, the flow of the purge gas is resumed through as well as the flow of the torch gases.

None of the above inventions and patents, taken either singly or in combination, is seen to describe the instant invention as claimed.

### SUMMARY OF THE INVENTION

The nitrogen saver for brazing is directed to a purge gas shutoff valve used in brazing of copper-based materials which is actuated by placement of a brazing torch on the end of a pivoting support arm. The pivoting support arm simultaneously opens or closes flow valves for a workpiece purge gas, e.g., nitrogen, and for torch gases used for brazing, e.g., oxygen and acetylene, depending on whether or not the torch is hung onto the support arm.

Accordingly, it is a principal object of the invention to provide a nitrogen saver for brazing in the form of a purge gas shutoff device that is actuated by hanging or removing a brazing torch from the end of a pivoting support arm.

It is another object of the invention to provide a nitrogen saver for brazing in which a support arm actuates shutoff valves for fuel and oxygen gases used in the brazing torch simultaneously with the actuation of the valve for the purge gas.

It is an object of the invention to provide improved elements and arrangements thereof in an apparatus for the purposes described which is inexpensive, dependable and fully effective in accomplishing its intended purposes.

None of the above references teach a welding system in which shut-off valves for the welding gases and purge gas are simultaneously actuated.

These and other objects of the present invention will become readily apparent upon further review of the following specification and drawings.

### BRIEF DESCRIPTION OF THE DRAWINGS

FIG. 1 is an environmental, perspective view of a nitrogen saver for brazing according to the present invention, shown mounted to a torch fuel and oxygen shutoff valve.

FIG. 2 shows an environmental, perspective view of the nitrogen saver for brazing according to the present invention with the nitrogen supply hose removed.

FIG. 3 is an exploded perspective view of the nitrogen saver for brazing according to the present invention.

FIG. 4 is an exploded cross-sectional view of the nitrogen saver for brazing according to the present invention.

FIG. 5A is a side view of the nitrogen saver for brazing according to the present invention.

FIG. 5B is a top view of the nitrogen saver for brazing according to the present invention.

Similar reference characters denote corresponding features consistently throughout the attached drawings.

### DETAILED DESCRIPTION OF THE PREFERRED EMBODIMENT

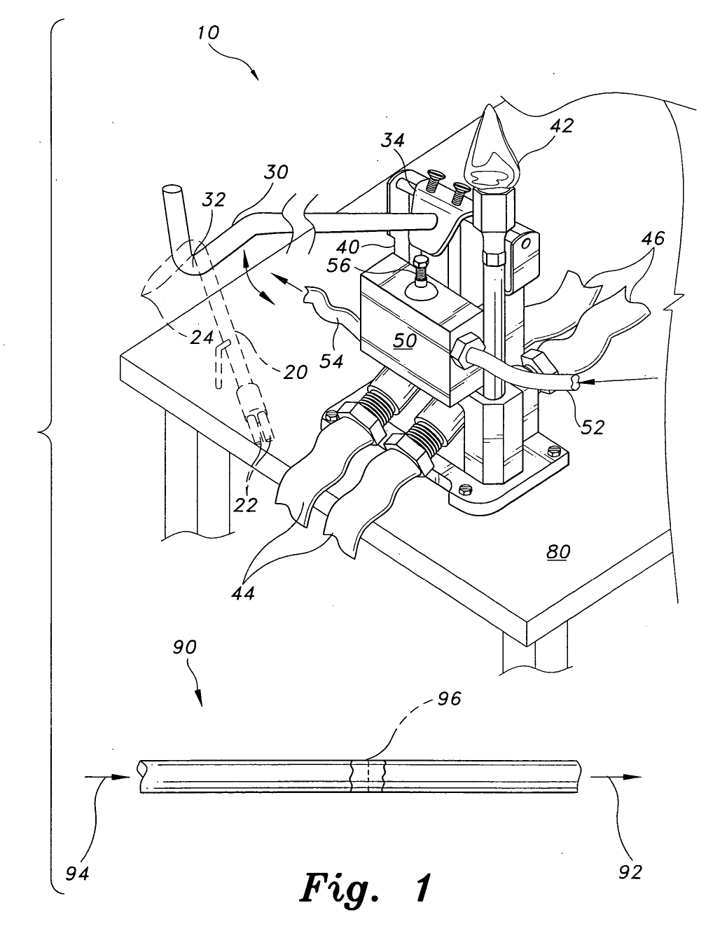

FIG. 1 shows a perspective view of a brazing installation 10 including a nitrogen saver for brazing in the form of a purge gas shutoff valve 50 mounted onto a dual torch gas shutoff valve 40. The dual torch gas shutoff valve 40 is preferably a Gasaver made by Smith Equipment of Watertown, S. Dak., a Weldit Gasaver, or similar device, and is fastened onto a support table 80. The dual inlet lines 46 provide fuel (e.g., acetylene or propane) and oxygen to the dual shutoff valve 40. When the dual shutoff valve 40 is open, the fuel and oxygen pass through their respective outlet lines 44, to the brazing torch 20 where they enter the torch through fittings 22. The fuel and oxygen mix together inside the body of the brazing torch 20 and the resulting combustible mixture exits the torch 20 at its tip 24.

The brazing torch 20 is shown (in phantom image) resting on the hooked end 32 of the pivoting arm 30. The arm 30 is attached at the opposite end to a bracket 34 that is movable pivotally on the dual shutoff valve 40 to simultaneously open or close the fuel and oxygen supplies to the brazing torch 20, depending upon whether the torch 20 is resting on the hooked end 32 of the pivoting arm 30.

As is known in the art, when brazing copper-based materials, a purge gas is used inside the work material to avoid the undesirable formation of scale. In this case, the purge gas is preferably nitrogen, although other inert gases, such as argon or helium can be used as well. The nitrogen gas enters the purge gas shutoff valve 50 at inlet 52 and, when the shutoff valve 50 is open, it flows out the exit 54 into the workpiece 90. The nitrogen flows through the workpiece from the inlet side 94 relative to the point 96 at which brazing takes place, to the outlet side 92.

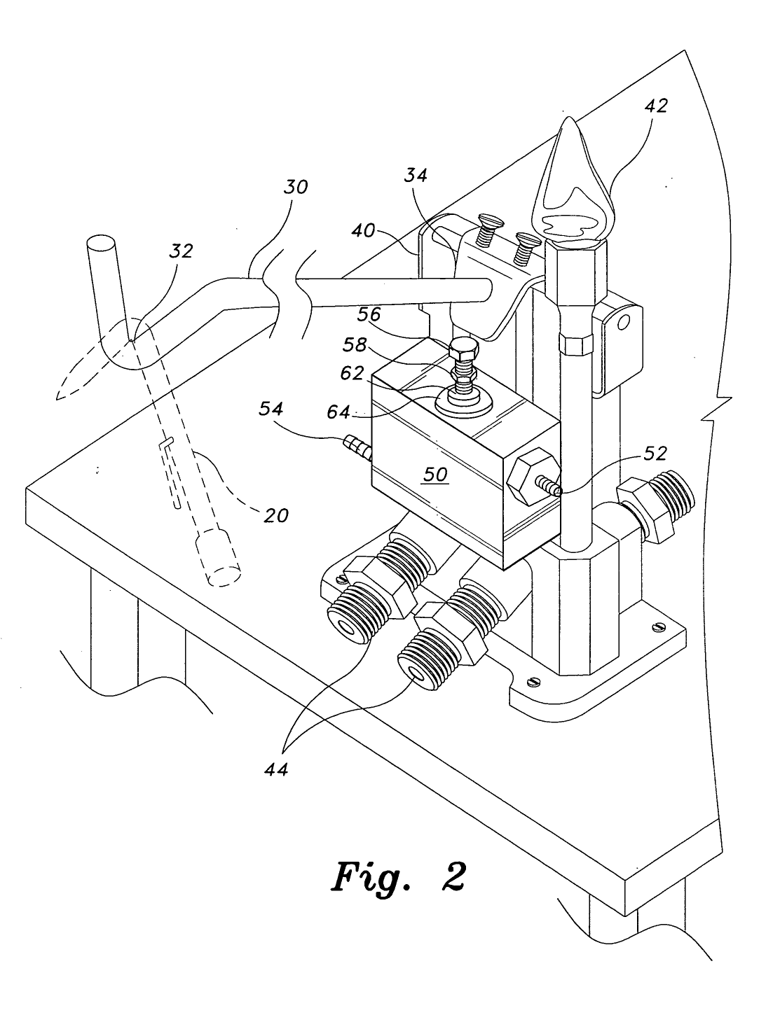

FIG. 2 shows a detailed view of the purge gas shutoff device 50 without the hoses and lines for the torch gases or purge gas attached. In FIGS. 1 and 2, the pivoting arm 30 is shown in the raised position. In this position, the dual valve 40 and the purge valve 50 are both open, i.e., all gases are flowing. The torch is usable for brazing the workpiece 90.

When brazing is complete, the torch 20 is hung onto the hook 32 at the end of the pivoting arm 30. In this position, the weight of the torch 20 forces the arm 30 downward causing the dual valve 40 and the purge gas valve 50 to close simultaneously, shutting off all gas flow. The movement of the bracket 34 during the downward stroke of the arm 30 causes the arm 30 to contact and press the top of the adjustment screw 56 causing plunger 62 to move downward, thereby closing the purge valve 50. During the same downward stroke of the arm 30, the dual valve 40 is also closed.

When the torch 20 is again removed from the hook 32 to resume brazing, the arm 30 again raises and the torch and purge gases resume flowing. A continuous pilot flame 42 is used to reignite the torch 20.

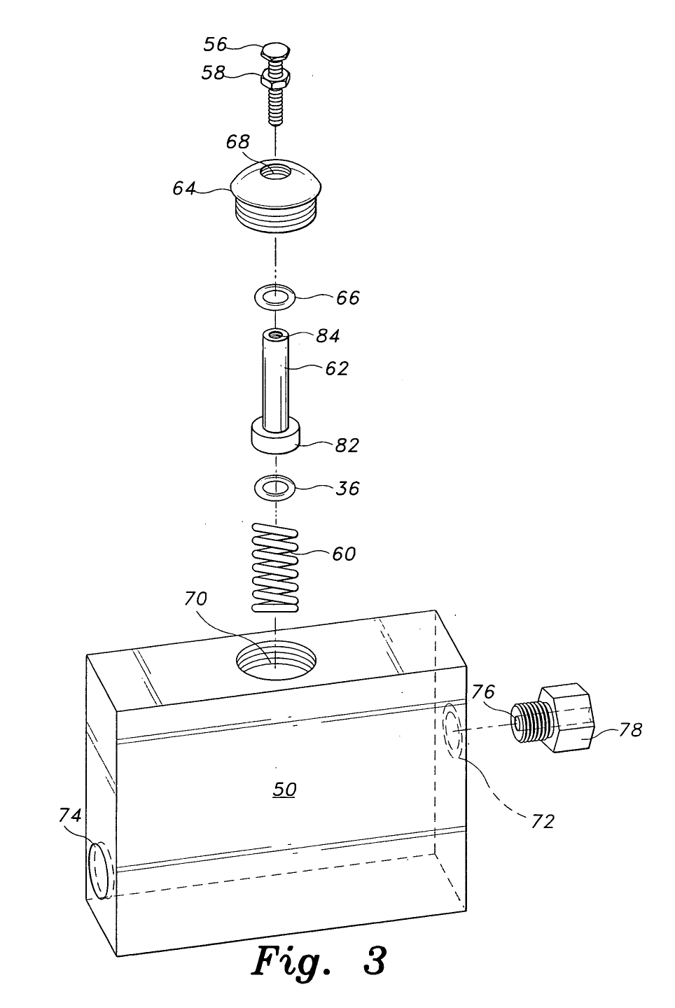

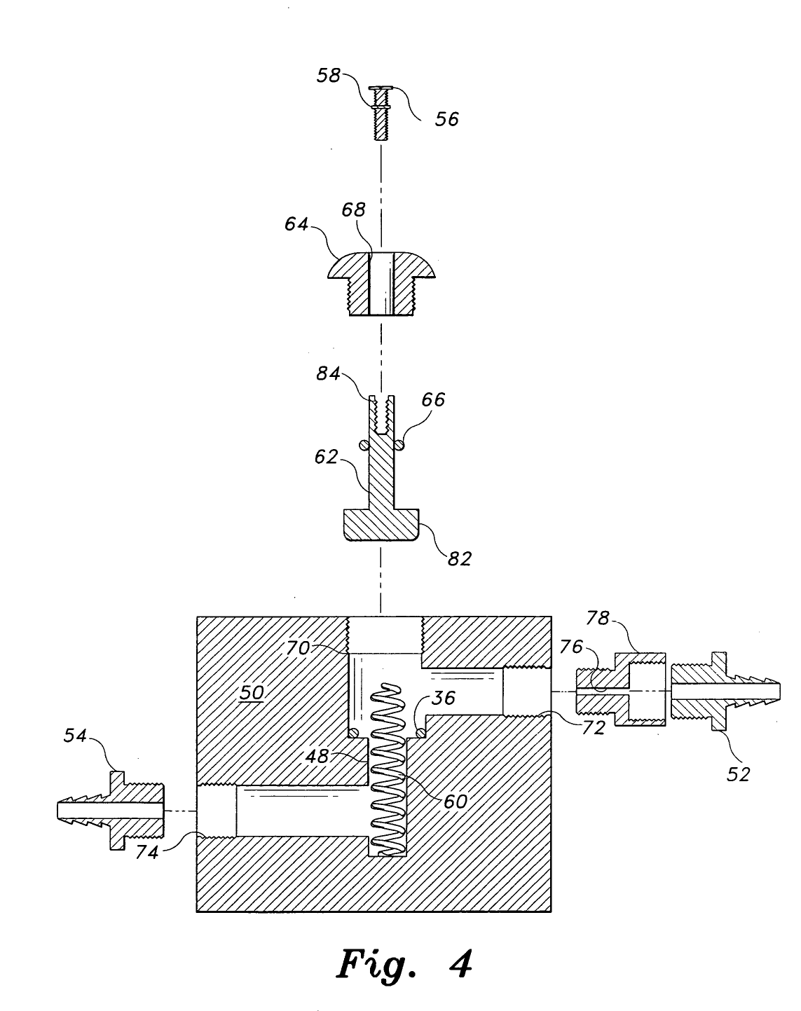

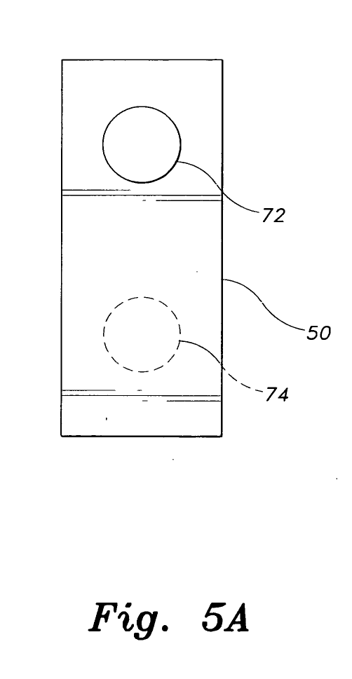

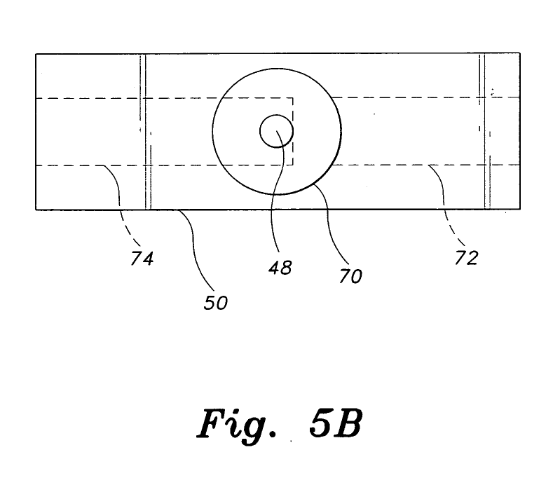

FIGS. 3 and 4 show exploded perspective and cross-sectional views, respectively, of the purge valve 50. In addition, FIGS. 5A and 5B show a side view from the inlet side and a top view of valve 50, respectively. The valve 50 includes a threaded inlet opening 72 and threaded outlet opening 74 for the purge gas. In order to reduce the pressure of the purge gas delivered to the workpiece to a satisfactory level, an inlet fitting 78 is provided with a pressure-reducing orifice 76.

Inlet fitting 52 attached to the end of a purge gas supply line is then threaded into the fitting 78. Also, an outlet fitting 54 is threaded into the outlet opening 74. Purge gas exiting through fitting 54 flows to the workpiece. Although not shown, the purge gas can enter the workpiece either through a hose placed in the open end of the workpiece or through any suitable fixture.

Inside purge valve 50, a plunger 62 moves reciprocally inside a corresponding vertical cylindrical cavity 70 of the valve 50 to permit or block fluid communication between the inlet 72 and the outlet 74, depending whether the plunger 62 is in the raised or lowered position, respectively. A compression spring 60 biases the valve 50 in the normally open position, corresponding to the arm 30 being in the raised position. Spring 60 rests in opening 48 in the body 50 of the valve.

A flange 82 extending outwardly from the side of the plunger 62 at its lower end has a diameter that corresponds with the inner diameter of the cylindrical opening 70 in the valve 50, making sealing contact with the sides of the opening while still being able to reciprocate up and down.

Also, when the plunger 62 is in its fully closed position, i.e., when the torch 20 is resting on the hook 32 of pivot arm 30 and pushing downward on the arm, a sealing ring 36 (such as an o-ring) resting inside opening 70 mates with the underside of the flange 82 of plunger 62 to ensure that the valve is closed.

When fully assembled as shown in FIGS. 1 and 2, a fitting 64 including an opening 68 therein holds the plunger inside the valve 50, while permitting the top of the plunger 62 to protrude upward toward the pivot arm 30 by the upward tension of the spring 60.

In the open position of valve 50, the plunger 62 extends upward, permitting purge gas to flow through openings 72 and 74 inside valve 50. Conversely, in the closed position, plunger 62 is lowered to block fluid communication between openings 72 and 74. An o-ring 66 provides an additional seal between the inside cavity 70 and the fitting 64.

Adjustment screw 56 includes a hex nut 58 to limit travel of the plunger 62, and can be set to correspond with the limits of movement of the pivoting arm 30. Screw 56 is threaded into corresponding opening 84 in the top of plunger 62.

It is to be understood that the present invention is not limited to the sole embodiment described above, but encompasses any and all embodiments within the scope of the following claims.

We claim:

1. A purge gas saver for a brazing installation, comprising:
a valve housing having a purge gas inlet passage, a purge gas outlet passage, and an intermediate gas passage orthogonal to and disposed between the inlet and outlet passages defined in the housing;
a plunger having an upper end with a threaded opening and a lower end, the plunger being slidably disposed in the intermediate passage, said plunger adjustable between an open position and a closed position;
an adjustment screw threadably engaged in the threaded opening of said plunger and extending from the upper end of the plunger; and
a compression spring disposed beneath the plunger inside of the intermediate gas passage, the spring biasing the plunger to an open position in order to permit a purge gas to flow through the valve housing from the inlet passage to the outlet passage;
wherein, the valve housing is adapted for attachment to a dual valve brazing installation for controlling flow of a fuel gas and oxygen with the adjustment screw disposed below a torch hanger arm of the brazing installation so that depressing the hanger arm depresses the plunger against the spring to block passage of the purge gas through the valve housing, whereby flow of the purge gas is controlled simultaneously with flow of the fuel gas and oxygen.

2. The purge gas saver according to claim 1, wherein the inlet passage further comprises a threaded inlet opening disposed on a first side of said valve housing.

3. The purge gas saver according to claim 2, wherein the outlet passage further comprises a threaded outlet opening disposed on a side of said valve housing opposite the threaded inlet opening.

4. The purge gas saver according to claim 1, wherein the intermediate gas passage comprises a threaded cavity defined in a top surface of said housing.

5. The purge gas saver according to claim 1, wherein said plunger further comprises an annular flange disposed about the lower end of the plunger, the flange having a diameter slightly less than the intermediate passage, the flange forming a seal against the intermediate passage.

6. The purge gas saver according to claim 1, further comprising a sealing ring resting inside of the intermediate passage and mating with the lower end of the plunger to ensure the intermediate passage is sealed.

7. The purge gas saver according to claim 1, further comprising a threaded fitting for holding the plunger inside of the valve housing, the threaded fitting engaging the threaded cavity disposed on the top surface of the valve housing, the fitting having an opening through the center thereof for allowing the adjustment screw to pass through the fitting to engage the opening in the upper end of the plunger.

8. The purge gas saver according to claim 1, further comprising an o-ring disposed around the upper end of the plunger to provide an additional seal between the threaded cavity and the fitting.

9. The purge gas saver according to claim 1, further comprising a hex nut adjustably secured to the adjustment screw for limiting the movement of the plunger.

10. The purge gas saver according to claim 2, further comprising a threaded inlet fitting engaged in the inlet opening having a pressure reducing orifice disposed through its center for reducing the pressure of the purge gas delivered through the valve housing.

11. A purge gas saving brazing installation, comprising:
a dual torch gas shutoff valve for controlling the flow of fuel and oxygen through the brazing installation;
dual inlet lines disposed on a first side of the gas shutoff valve for supplying fuel and oxygen to the shutoff valve;
dual outlet lines disposed on a side of the gas shutoff valve opposite the inlet lines for delivering fuel from the shutoff valve;
a brazing torch having-a first end with a torch tip disposed thereon and a second end having a pair of torch fittings disposed thereon, whereby the dual outlet lines are secured to the torch fittings to supply fuel and oxygen from the gas shutoff valve to the brazing torch, the oxygen and fuel each flowing through separate lines and then mixing inside of the brazing torch;
a pivot arm having a hook end for supporting the brazing torch, the pivot arm being secured to the shutoff valve by a bracket that is pivotally mounted on the dual shutoff valve and movable to open and close the fuel and oxygen supplies to the brazing torch;
a valve housing having a purge gas inlet passage, a purge gas outlet passage, and an intermediate gas passage orthogonal to and disposed between the inlet and outlet passages defined in the housing;
a plunger having an upper end with a threaded opening and a lower end, the plunger being slidably disposed in the intermediate passage, said plunger adjustable between an open position and a closed position;
an adjustment screw threadably engaged in the threaded opening of said plunger and extending from the upper end of the plunger; and
a compression spring disposed beneath the plunger inside of the intermediate gas passage, the spring biasing the plunger to an open position in order to permit a purge gas to flow through the valve housing from the inlet passage to the outlet passage;
wherein, the valve housing is adapted for attachment to a dual valve brazing installation for controlling flow of a fuel gas and oxygen with the adjustment screw disposed below the pivot arm of the brazing installation so that depressing the pivot arm depresses the plunger against the spring to block passage of the purge gas through the valve housing, whereby flow of the purge gas is controlled simultaneously with flow of the fuel gas and oxygen.

12. The brazing installation according to claim 11, wherein the inlet passage further comprises a threaded inlet opening disposed on a first side of said valve housing.

13. The brazing installation according to claim 12, wherein the outlet passage further comprises a threaded outlet opening disposed on a side of said valve housing opposite the threaded inlet opening.

14. The brazing installation according to claim 11, wherein the intermediate gas passage comprises a threaded cavity defined in a top surface of said housing.

15. The brazing installation according to claim 11, wherein said plunger further comprises an annular flange disposed about the lower end of the plunger, the flange having a diameter slightly less than the intermediate passage, the flange forming a seal against the intermediate passage.

16. The brazing installation according to claim 11, further comprising a sealing ring resting inside of the intermediate passage and mating with the lower end of the plunger to ensure the intermediate passage is sealed.

17. The brazing installation according to claim 11, further comprising a threaded fitting for holding the plunger inside of the valve housing, the threaded fitting engaging the threaded cavity disposed on the top surface of the housing, the fitting having an opening through the center thereof for allowing the adjustment screw to pass through the fitting to engage the opening in the upper end of the plunger.

18. The brazing installation according to claim 11, further comprising an o-ring disposed around the upper end of the plunger to provide an additional seal between the threaded cavity and the fitting.

19. The brazing installation according to claim 11, further comprising a hex nut adjustably secured to the adjustment screw for limiting the movement of the plunger.

20. The brazing installation according to claim 12, further comprising a threaded inlet fitting engaged in the inlet opening having a pressure reducing orifice disposed through its center for reducing the pressure of the purge gas delivered through the valve housing.
